(19) United States
(12) Patent Application Publication
(10) Pub. No.: US 2026/0250609 A1
(43) Pub. Date: Aug. 27, 2026

(54) LIQUID LAUNDRY DETERGENT FORMULATION

(71) Applicant: Novozymes A/S, Bagsvaerd (DK)

(72) Inventors: Sidharth RAMANAND, Herlev (DK); Erhan CAKMAR, Bagsvaerd (DK)

(73) Assignee: Novozymes A/S, Bagsvaerd (DK)

(21) Appl. No.: 18/877,509

(22) PCT Filed: Jun. 26, 2023
(86) PCT No.: PCT/EP2023/067221

§ 371 Date: Dec. 20, 2024

(30) Foreign Application Priority Data
Jun. 29, 2022 (EP) 22181758.8
Oct. 25, 2022 (EP) 22203604.8

(51) Int. Cl. C11D 10/04; C11D 1/29; C11D 1/66; C11D 3/04; C11D 3/20; C11D 3/48

(52) U.S. Cl. CPC C11D 10/045; C11D 3/046; C11D 3/2065; C11D 3/2068; C11D 3/2086; C11D 3/48; C11D 1/29; C11D 1/662

(57) ABSTRACT

The present invention relates to liquid laundry detergent formulations with plant based biodegradable surfactant and fermented surfactant.

### REFERENCE TO SEQUENCE LISTING

This application contains a Sequence Listing in computer readable form. The computer readable form is incorporated herein by reference.

### FIELD OF THE INVENTION

The present invention relates to liquid laundry detergent formulations with plant based biodegradable surfactant and fermented surfactant.

### BACKGROUND OF THE INVENTION

Detergent compositions are well known to include a large number of ingredients, offering particular functionality throughout the cleaning process. However, some detergent ingredients have faced scrutiny due to potential environmental concerns most of all for not being sustainable because they are from a non-renewable source and are poorly biodegradable or even persistent in the environment. It is desirable to provide alternatives that have an improved sustainability profile while maintaining compatibility with other detergent ingredients. In addition, the consumer benefits and performance effects must be maintained.

### SUMMARY OF THE INVENTION

Petrochemically derived detergent ingredients are not sustainable because they are derived from a non-renewable source and are often poorly biodegradable or even persistent in the environment. The inventors of the present invention have been able to reduce the total amount of surfactant compared to commercially available environmentally friendly detergent while at the same time maintaining wash performance by partly replacing surfactant with enzymes.

The plant-based green formulation of the present invention is a sustainable and cost-effective formulation as compared to a commercial plant-based benchmark. The cost-window provides an opportunity to incorporate more of enzymes to improve wash performance-stain removal, and whiteness.

In summary, the invention provides new detergent where surfactants can be replaced by enzymes, that is more compact than existing environmentally friendly detergent, has a reduced environmental impact compared to traditional fossil-based detergents and maintains wash performance.

### DETAILED DESCRIPTION OF THE INVENTION

### Definitions

In accordance with this detailed description, the following definitions apply. Note that the singular forms “a,” “an,” and “the” include plural references unless the context clearly dictates otherwise.

The pH of the formulation is that of 3.3 gram of the liquid laundry detergent composition dissolved in one litre of demineralised water at 25° C.

Unless defined otherwise or clearly indicated by context, all technical and scientific terms used herein have the same meaning as commonly understood by one of ordinary skill in the art to which this invention belongs.

Unless defined otherwise or clearly indicated by context, all component levels provided herein are made in reference to the active level of that component.

Percentage of a product is the product in protonated form where relevant.

All percentages and ratios of components are calculated by weight unless otherwise indicated. All percentages are calculated based on the total composition unless otherwise indicated.

### Detergent Composition

The term “detergent composition” refers to compositions that find use in the removal of undesired compounds from items to be cleaned, such as textiles, dishes, and hard surfaces. The detergent composition may be used to e.g. clean textiles, dishes and hard surfaces for both household cleaning and industrial cleaning and/or for fabric care. The terms encompass any materials/compounds selected for the particular type of cleaning composition desired and the form of the product (e.g., liquid, gel, powder, granulate, paste, or spray compositions) and includes, but is not limited to, detergent compositions (e.g., liquid and/or solid laundry detergents and fine fabric detergents; hard surface cleaning formulations, such as for glass, wood, plastic, ceramic and metal counter tops and windows; carpet cleaners; oven cleaners; fabric fresheners; fabric softeners; and textile and laundry pre-spotters, as well as dish wash detergents). In addition to containing an enzyme of the invention, the detergent formulation may contain one or more additional enzymes (such as amylases, proteases, peroxidases, cellulases, betaglucanases, xyloglucanases, hemicellulases, xanthanases, xanthan lyases, lipases, acyl transferases, phospholipases, esterases, laccases, catalases, aryl esterases, amylases, alpha-amylases, glucoamylases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases (GH5 and/or GH26), licheninases, phosphodiesterases, pectin methylesterases, cellobiohydrolases, transglutaminases, nucleases, and combinations thereof, or any mixture thereof), and/or detergent components such as surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, tannish inhibitors, optical brighteners, bactericides, fungicides, soil suspending agents, soil release polymers, anti-redeposition agents, enzyme inhibitors or stabilizers, enzyme activators, antioxidants, and solubilizers. The detergent composition may comprise of one or more of any type of detergent component.

### Improved Wash Performance

The term “improved wash performance” is defined herein as an enzyme displaying an increased wash performance in a detergent composition relative to the wash performance of a reference enzyme, e.g., by increased color clarification and/or anti-pilling effect, when evaluating the fresh samples and/or after the samples have been stored under the same conditions. The term “improved wash performance” includes wash performance in laundry but also in, e.g., hard surface cleaning such as automated dish wash (ADW).

### Plant Based Surfactants

Plant based surfactants are surfactants based on constituents derived from plants such as palm kernel oil or coconut oil and glucose and vegetable oils respectively.

### Textile

The term “textile” means any textile material including yarns, yarn intermediates, fibers, nonwoven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used, it is intended to include the broader term textiles as well.

### Wash Liquor

The term “wash liquor” refers to an aqueous solution containing a detergent composition in dilute form, such as but not limited to a detergent solution containing a laundry detergent composition in dilute form such as the wash liquor in a laundry process.

### Wash Performance

The ability to remove or reduce stains from laundry Whiteness

### Whiteness

The term “Whiteness” is defined herein as a broad term with different meanings in different regions and for different consumers. Loss of whiteness can e.g. be due to greying, yellowing, or removal of optical brighteners/hueing agents. Greying and yellowing can be due to soil redeposition, body soils, coloring from e.g. iron and copper ions or dye transfer. Whiteness might include one or several issues from the list below: colorant or dye effects; incomplete stain removal (e.g. body soils, sebum etc.); redeposition (greying, yellowing or other discolorations of the object) (removed soils re-associate with other parts of textile, soiled or unsoiled); chemical changes in textile during application; and clarification or brightening of colors.

### Exemplary Liquid Laundry Detergent Formulation of the Invention

The present invention concerns a laundry detergent formulation comprising
6-10% anionic surfactant such as AES (Alkyl Ether Sulfate), AS (Alkyl Sulfate), preferably SLES with 1-3 moles of ethoxylation, MES (Methyl Ester Sulphonate), OS (Olefin Sulphonate), Sophorolipids
3-10% non-ionic surfactant, such as alkyl polyglucoside (APG), preferably APG, C₈-C₁₄ glucoside (alkyl polyglucoside), FAEO-Fatty Alcohol Ethoxylate with 3-9 moles of ethoxylation, Rhamnolipids, Glucamides
3-8% builder, such as citric acid, or substoichiometric quantities of GLDA (N,N-Dicarboxymethyl glutamic acid tetrasodium salt), MGDA (methylglycinediacetic acid trisodium salt), CMI Carboxymethyl inulines, EDDS Ethylenediamine disuccinic acid or preferably sodium citrate
1-5% soap, preferably obtained from coco fatty acid or palm kernel oil fatty acid
3-10% solvent, preferably polyol such as glycerol
0.4-0.7% preservative, preferably phenoxyethanol (2-phenoxyethan-1-ol), sodium benzoate, potassium sorbate, organic acids
0.4-0.7% viscosity modifier, preferably sodium chloride or hydroxy ethyl cellulose
Add water to 100%

Enzymes as desired may be added to the detergent formulation.

pH of the final laundry detergent formulation is in the range 8-9, preferably 8.2-8.8, more preferably 8.4-8.6.

Ingredients useful in the formulation of the liquid laundry detergent formulation of the present invention are described in more detail below.

### Anionic Surfactants

Anionic surfactants are the workhorses of laundry detergents and thus difficult to replace. One of the most prominent anionic surfactants is linear alkylbenzenesulfonates (LAS) which contains a spread of chain length, but since LAS is based on non-renewable sources and not allowed in products with ecolabels it is important in the context of the present invention to find alternative anionic surfactant(s) that has a far more sustainable profile. In the pursuit of such alternative to LAS alkyl ethoxysulfates, in particular SLES, has shown useful.

Alkyl ethoxysulfates (AES, alkylpoly(oxyethylene) sulfate) have the general formula CH₃(CH₂)ₘ(OCH₂CH₂)ₙOSO₃⁻ and comprise the combination of a nonionic group with an anionic one. It is a common type of anionic for liquid detergents, usually those that are citrate-built. SLES is a particular AES with the chemical formula CH₃(CH₂)₁₁(OCH₂CH₂)ₙOSO₃Na. The product is heterogeneous in the number of ethoxy groups, where n is the mean, e.g. SLES, 2EO indicates the presence of two ethoxy groups.

SLES is prepared by ethoxylation of dodecyl alcohol, which is produced industrially from palm kernel oil or coconut oil and is considered safe for consumer use: tests in the US indicate that it is safe for consumer use and The Australian government's Department of Health and Ageing and its National Industrial Chemicals Notification and Assessment Scheme (NICNAS) have determined that SLES does not react with DNA.

### Non-Ionic Surfactants

Nonionic surfactants contribute oil emulsification properties to detergents, are mostly easily formulated into liquid detergents. Detergents typically contain 3-10% nonionic surfactant but liquid formulations may often contain more. There is a broad variety of non-ionic surfactants, of which some are almost used only industrially due to toxicology and biodegradability issues, e.g. alkylphenol ethoxylate (APE).

APG (alkyl polyglucosides) is a sugar-based surfactant characterized by a saccharide unit and a hydrophobic alkyl chain. APGs may differ in the alkyl chain length, both linear and monobranched, and in the degree of polymerisation of the saccharide. APG is considered attractive non-ionic surfactants widely used in the food, pharmaceutical, and cosmetic industries due to their low toxicity, biodegradability, and production from natural renewable resources. In a preferred embodiment of the present invention the alkyl length is in the range 6-16 and the degree of polymerisation is 1-3.

Other non-ionic surfactants are bio-based surfactants e.g. wherein the surfactant is a sugar-based non-ionic surfactant which may be a hexyl-β-D-maltopyranoside, thiomaltopyranoside or a cyclic-maltopyranoside, such as described in EP2516606 B1. Sophorolipid and rhamnolipid are also considered relevant. Sophorolipids are glycosides and esters of the disaccharide sophorose (beta-D-glucopyranosyl-(1→2-D-glucose) in combination with a hydroxyfatty acid. They exist in a closed (lactone), and thus nonionic, form present at low to moderate pH, and an open form, which appears at high pH in which form the sophorolipid is anionic. Rhamnolipid is a glycolipid that may be in the form of a mono-rhamnolipid or a di-rhamnolipid which consists of one or two rhamnose groups, and a 3-(hydroxyalkanoyloxy)alkanoic acid (HAA) fatty acid tail, such as 3-hydroxydecanoic acid.

### Builders

Builder is added to remove in particular Ca²⁺ and Mg²⁺ from water as these heavily impair the performance of the anionic surfactants. Traditionally phosphates have been the builder of choice, but the use has been heavily reduced—or even banned—due to its potential to cause eutrophication.

Sodium citrate (i.e. the sodium salt of 2-hydroxypropane-1,2,3-tricarboxylate) is a widely used builder in liquid detergents. Sodium citrate is produced from renewable raw materials, biodegradable and inexpensive.

### Soap

Soap is obtained by the saponification of fat, that is, salts of fatty acid carboxylates such as: CH₃[CH₂]ₙCH₂COO⁻, where n may vary within a particular soap source, e.g. soap made of coco fatty acid comprises the main fatty acids found in coconut oil, i.e. lauric acid (12:0), myristic acid (14:0), palmitic acid (16:0), oleic acid (18:1 omega-9), stearic acid (18:0) and linoleic acid (18:2 omega-6) representing from about 49% down to about 2% of the fatty acids in coco fatty acid. The salts are preferably selected from alkali metal salts (in particular sodium (Na) and potassium (K)), MEA (monoethanolamine, i.e., 2-aminoethan-1-ol, NH₂CH₂CH₂OH), DEA (diethanolamine”, i.e., 2,2′-iminodiethan-1-ol, NH(CH₂CH₂OH)₂) and TEA (triethanolamine, i.e., 2,2′,2″-nitrilotriethan-1-ol, N(CH₂CH₂OH)₃). Because of the formation of toxic byproducts in the manufacture of DEA, this ingredient is less desirable as a salt.

In the context of the present invention soap based on coco fatty acid is preferred along with soaps based on palm kernel fatty acid as these come from renewable, plant-based sources, have mild detergency and used in detergents for cleaning applications.

### Solvents

Unstructured liquid detergents, i.e. isotropic solutions of surfactants and builders may also contain solvents such as ethanol, isopropyl alcohol (propan-2-ol) and polyols. Polyols are good solvents for surfactant systems and are typically selected from glycerol (propane-1,2,3-triol), MPG (propane-1,2-diol), diethylene glycol (2,2′-Oxydi(ethan-1-ol)) and dipropylene glycol (a mixture of three isomeric chemical compounds, 4-oxa-2,6-heptandiol, 2-(2-hydroxy-propoxy)-propan-1-ol, and 2-(2-hydroxy-1-methyl-ethoxy)-propan-1-ol).

Generally 2-5% polyol leads to stabilization of enzymes present in the detergent.

In liquid detergents solvents are also often termed hydrotropes; the two terms may be used interchangeably.

### Preservatives

Phenoxyethanol (2-phenoxyethan-1-ol), isothiazolinones such as benzisothiazol-3 (2H)-one (Proxel™) and 2-methylisothiazol-3(2H)-one, Bronopol (2-bromo-2-nitropropane-1,3-diol), and lactic acid. The various preservatives are subject to varying regulatory restrictions and their effectiveness depends on pH and other ingredients.

For the purpose of the present invention, it has been important to select a preservative that is as environmentally friendly as possible while still acting as both a fungicide and a bactericide (broad spectrum). For that reason phenoxyethanol, sodium benzoate, potassium sorbate or organic acids are preferred over allergenic isothiazolinones and other formaldehyde releasing preservatives such as Bronopol.

### Viscosity Modifiers

In principle, all the ingredients in a liquid detergent composition influence the viscosity of the final product. Some are added more specifically for this purpose, such as amine oxides and betaines. Xanthan gum may also used as a thickener. For the purpose of this invention sodium salts, e.g. sodium sulfate or magnesium sulfate or magnesium chloride or preferably sodium chloride are favored.

### Polymers

Generally, it is preferred to avoid polymers as they are derived from petrochemical, non-renewable resources, and they can be (partly or fully) replaced by enzymes, in particular DNase, cellulase or xyloglucanase (see e.g. WO 2021/0580222 and WO 2021/058023). To the extent that polymers are added for e.g. soil release they can be selected from e.g. poly(ethylene imine) and polyethylene and/or polypropylene terephthalates.

### Enzymes

Enzymes may improve the wash performance of the liquid laundry detergent and may be added as desired. Preferably one or more enzymes are selected for group consisting of amylases, proteases, peroxidases, cellulases, betaglucanases, xyloglucanases, hemicellulases, xanthanases, xanthan lyases, lipases, acyl transferases, phospholipases, esterases, laccases, catalases, aryl esterases, amylases, alpha-amylases, glucoamylases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases, pectin methylesterases, cellobiohydrolases, transglutaminases, licheninases, laminarinases, and DNAses, or any combination thereof. The skilled person will know that amount of enzyme depends on the type of enzyme as well as the actual wash conditions (e.g. country/region, detergent for colored or white laundry), but in general the amount of enzyme is in the range of 10 ppm to 700 ppm in the liquid detergent.

### Detailed Liquid Laundry Detergent Formulations of the Invention

The inventors of the present invention have surprising found that liquid laundry detergent formulation comprising the following ingredients (in wt. %) has parity performance with commercially available environmentally friendly liquid laundry detergent Ecover, non bio:
8% AES, preferably SLES, more preferably SLES, 2EO
4% alkyl polyglucoside (APG), preferably APG, C₈-C₁₄ glucoside
4% sodium citrate
2% soap, preferably obtained from coco fatty acid
4% polyol such as glycerol
0.5% viscosity modifier, preferably sodium chloride

0.4-0.6% preservative, preferably phenoxyethanol (2-phenoxyethan-1-ol), can be added to the final product. The total percentage of surfactant in the above formulation amounts to 14% (including soap), which is well below the level of surfactant in the above mentioned commercially available detergent (17-18%). It is evidenced in the experimental section that the initial decline in wash performance on the stain removal and whiteness caused by the reduced total surfactant level is fully compensated by the addition of enzymes (Medley® Pure 300L and/or the cellulase having SEQ ID NO: 1). Consequently, the inventors of the present invention have replaced surfactants with completely renewable, biodegradable and non-petrochemically derived enzymes while maintaining performance.

### EMBODIMENTS OF THE INVENTION

The following embodiments discloses liquid detergent formulations of the invention and use thereof:
1. A liquid laundry detergent composition comprising
   a. 7-9% preferably 8% AES
   b. 3-5%, preferably 4% APG
   c. 3-5%, preferably 4% builder
   d. 1-3%, preferably 2% soap
   e. 3-5%, preferably 4% polyol
2. The liquid laundry detergent composition according to embodiment 1 further comprising less than 0.7% preservative, such as 0.2%-0.7%, preferably 0.4%-0.6% preservative, and a less than 0.7% viscosity modifier, such as 0.2%-0.7%, preferably 0.4%-0.6% viscosity modifier.
3. The liquid laundry detergent composition according to any of embodiments 1 or 2, wherein
   a. AES is SLES, preferably SLES, 2EO.
   b. APG is APG, C₈-C₁₄ glucoside
   c. Builder is sodium citrate
   d. Soap is obtained from coco fatty acid
   e. Polyol is glycerol
4. The liquid laundry detergent composition according to any of embodiments 2 or 3, wherein the preservative is 0.5% phenoxy ethanol and the viscosity modifier is 0.5% sodium chloride.
5. A liquid laundry detergent composition according to any of embodiments 1 to 4 comprising
   a. 8% SLES, 2EO
   b. 4% C₈-C₁₄ glucoside
   c. 4% sodium citrate
   d. 2% soap obtained from coco fatty acid
   e. 4% glycerol
6. The liquid laundry detergent composition according to any of the preceding embodiments further comprising one or more enzymes selected for group consisting of amylases, proteases, peroxidases, cellulases, betaglucanases, xyloglucanases, hemicellulases, xanthanases, xanthan lyases, lipases, acyl transferases, phospholipases, esterases, laccases, catalases, aryl esterases, amylases, alpha-amylases, glucoamylases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases, pectin methylesterases, cellobiohydrolases, transglutaminases, licheninases, laminarinases, and DNAses, or any combination thereof.
7. The liquid laundry detergent composition according to any of the preceding embodiments, wherein the pH of the formulation when dissolved 3.3 g/l in demineralised water at 25° C. is from pH 4 to 10, preferably from 6 to 9, more preferably from 8 to 9.
8. A domestic method for treating a textile, comprising the steps of
   a. Treating a textile with an aqueous solution of 0.15 to 20 g/L, more preferably 1 to 10 g/L of the detergent composition according to any of embodiments 1 to 7.
   b. Optionally rinsing and drying the textile.

### EXAMPLES

### Materials and Methods

### Detergent

Ecover Non-bio, no enzyme (commercially available, without enzymes)
Plant-based green detergent

TABLE 1
Plant-based green detergent; pH of the detergent is 8.5.
Plant-based green detergent formulation

| Component | Active amount (wt. %) |
|---|---|
| SLES, 2EO | 8 |
| APG, C₈-C₁₄ glucoside | 4 |
| Sodium citrate | 4 |
| Phenoxyethanol | 0.5 |
| Soap, coco fatty acid | 2 |
| Glycerol | 4 |
| Sodium chloride | 0.5 |

### Swatches

The swatches include a combination of food, technical stains and soil.

TABLE 2
Swatches

| Material | Source |
|---|---|
| C-01; Mineral oil with Carbon black | CFT |
| PC-S-132; High discriminative sebum BEY with | CFT |
| pigment | |
| C-S-132; High discriminative sebum BEY with | CFT |
| pigment | |
| C-S-10; Butter fat with colourant | CFT |
| WE5BBPC2; Cooked beef fat | CFT |
| W-20D; Pigment/Sebum, WFK | CFT |
| C-S-17; Fluid make-up | CFT |
| NZ-H002; Lard/Carotene | CFT |
| C-S-32; Sebum BEY with carbon black | CFT |
| C-S-98; Sebum JIS C9606 | CFT |
| PC-10; Pigment, Oil, Milk | CFT |
| 131KC; Cooked Beef Fat | Warwick Equest |
| WE5DASBWKC; Sheep Blood - double app | Warwick Equest |
| C-S-07; Grass | CFT |
| WE5GMWKC; Grass & Mud | Warwick Equest |
| E-117; Blood, Milk, Ink | CFT |
| C-S-406; Salad dressing Balsamico | CFT |
| C-S-26; Corn starch, coloured | CFT |
| C-S-28; Rice starch, coloured | CFT |
| C-S-44; Chocolate drink, pure | CFT |
| C-S-68; Chocolate ice cream, aged | CFT |
| KC-H097; Oat milk coloured with chocolate | CFT |
| KC-H141; Pectin without sugar | CFT |
| P01-KC; Tangerine | Warwick Equest |
| PC-H344; DNA stain | CFT |
| C-S-97; Highly discriminative tea | CFT |
| W-10 J; Tea | CFT |
| KC-H109; Coffee | CFT |
| KC-H026; Red wine | CFT |
| WE5FSMWKC; French Mustard | Warwick Equest |
| WE5TPWKC; Tomato Puree | Warwick Equest |
| C-S-15; Bil(blue)berry juice | CFT |
| W-SBL 2004; Soil Ballast Load version 2004 | CFT |
| RD-Liq01; Carbon black | CFT |

### Fabrics

The fabrics include a combination of cotton, polycotton and synthetic standard textiles.

TABLE 3
Fabrics

| Material | Source |
|---|---|
| W-80A; Cotton, knitwear | CFT |
| CN-42; Cotton, interlock, double jersey, with optical | CFT |
| brightener | |
| CN-11; Cotton, cretonne, woven, bleached, without | CFT |
| optical brightener | |
| T-266; Viscose, challis | CFT |
| W-10A; Cotton (WFK standard) | CFT |
| W-20A; Polyester/Cotton | CFT |
| T-720; Polyester, texturized, double knit jersey | CFT |
| W-30A; Polyester | CFT |
| W-40A; Polyamide | CFT |
| W-12AW; Cotton terry cloth, without optical brightener | CFT |

The above commercial test materials are available from Center for Testmaterials BV, Stoomloggerweg 11, 3133 KT Vlaardingen, the Netherlands or from Warwick Equest Ltd., Unit 55, Consett Business Park, Consett, County Durham, DH8 6BN, UK.

### Enzymes

Medley® Pure 300 L—a liquid enzyme blend comprising protease, amylase, pectate lyase, mannanase and lipase. Medley® Pure 300 L is available from Novozymes A/S upon request.
Cellulase having SEQ ID NO: 1:

QKPGETKEVH PQLTTFRCTK RGGCKPATNF IVLDSLSHPI
HRAEGLGPGG CGDWGNPPPK DVCPDVESCA KNCIMEGIPD
YSQYGVTTNG TSLRLQHILP DGRVPSPRVY LLDKTKRRYE
MLHLTGFEFT FDVDATKLPC GMNSALYLSE MHPTGAKSKY
NPGGAYYGTG YCDAQCFVTP FINGLGNIEG KGSCCNEMDI
WEANSRASHV APHTCNKKGL YLCEGEECAF EGVCDKNGCG
WNNYRVNVTD YYGRGEEFKV NTLKPFTVVT QFLANRRGKL
EKIHRFYVQD GKVIESFYTN KEGVPYTNMI DDEFCEATGS
RKYMELGATQ GMGEALTRGM VLAMSIWWDQ GGNMEWLDHG
EAGPCAKGEG APSNIVQVEP FPEVTYTNLR WGEIGSTYQE
VQKPKPKPGH GPRSD

Phosphodiesterase having SEQ ID NO: 2:

VPVNPEPDAT SVENVALKTG SGDSQSDPIK ADLEVKGQSA
LPFDVDCWAI LCKGAPNVLQ RVNEKTKNSN RDRSGANKGP
FKDPQKWGIK ALPPKNPSWS AQDFKSPEEY AFASSLQGGT
NAILAPVNLA SQNSQGGVLN GFYSANKVAQ FDPSKPQQTK
GTWFQITKFT GAAGPYCKAL GSNDKSVCDK NKNIAGDWGF
DPAKWAYQYD EKNNKFNYVG K

### Example 1: Terg-O-Tometer (TOM) Assay for WP

The terg-o-tometer is an industry standard. 1 L of wash solution is incubated in a water bath temperature-controlled environment. The solution is mixed for 5 min before adding 1 L to each of the beakers. The temperature in the beakers is measured to be 30.0° C. or required temperature. The washed and rinsed swatches are left to dry overnight in a drying cabinet and measured as indicated in table 2 below.

TABLE 4
Conditions for Terg-o-tometer Washing Trial

| Detergent dosage | 3.33 | g/L |
|---|---|---|
| Test solution volume | 1 | L |
| Fabric load | Up to 30 g | |
| pH | Unadjusted | |
| Wash time | 30 | minutes |
| Temperature | 30° | C. |
| Water hardness | 15° | dH |
| Ca²⁺:Mg²⁺:CO₃²⁻ ratio | 4:1:7.5 | |
| Soil | W-SBL2004 | |
| Mechanical action | 120 | rpm |

### Example 2: Method for Evaluation of Wash Performance (WP)

Wash performance is expressed as a delta remission value (ΔRem). After washing and rinsing the swatches are spread out flat and allowed to air dry at room temperature overnight. Light reflectance evaluations of the dry swatches are done using a Datacolor 800V reflectance spectrophotometer with large aperture. The measurements are made without UV in the incident light and remission at 460 nm is extracted. Measurement with small aperture through 2 layers (2 of the same type of swatch from the same beaker), 1 measurement on each swatch on the front side marked with beaker and swatch number. Calculating the enzyme effect is done by taking the measurements from washed swatches with enzymes and subtract with the measurements from washed without enzyme for each stain. The total enzyme performance is calculated as the average of individual ΔRem.

### Example 3: Method for Evaluation of Whiteness by TOM Assay

Whiteness is expressed as a delta remission value (ΔRem). After washing and rinsing the swatches are spread out flat and allowed to air dry at room temperature overnight. Light reflectance evaluations of the swatches are done using a Datacolor 800V reflectance spectrophotometer with large aperture. The measurements are made without UV in the incident light and remission at 460 nm is extracted. Measurement with small aperture through 2 layers (2 of the same type of swatch from the same beaker), 1 measurement on each swatch on the front side marked with beaker and swatch number. Calculating the enzyme effect is done by taking the measurements from washed swatches with enzymes and subtract with the measurements from washed without enzyme for each stain. The total enzyme performance is calculated as the average of individual ΔRem.

TABLE 5
Conditions for Terg-o-tometer Whiteness: SBL2004 is
soil ballast on a swatch, and Carbon black is a liquid
product added as soil. 2 pieces of 5*5 cm SBL2004 and
0.15 g/L of Carbon Black was used for the study.

| Detergent dosage | 3.33 | g/L |
|---|---|---|
| Test solution volume | 1 | L |
| Fabric load | Up to 30 g | |
| ph | Unadjusted | |
| Wash time | 60 | minutes |
| Temperature | 30° | C. |
| Water hardness | 15° | dH |
| Ca²⁺:Mg²⁺:CO₃²⁻ ratio | 4:1:7.5 | |
| Soil | W-SBL2004 with Carbon black | |
| Mechanical action | 120 | rpm |

### Example 4: Results from Evaluation of Wash Performance (WP)

The TOM assay (Example 1) was used to evaluate Was Performance as described in Example 2. WP of the following three detergents was evaluated:
Plant-based green detergent (PBG)
Plant-based green detergent (PBG) and addition of 3% Medley® Pure 300L (MP300L)
Commercial benchmark detergent (Ecover Non-bio, no enzyme)

The outcome of the WP evaluation on different stains is provided below:

TABLE 6
Delta remission at 460 nm values for WP

| | | PBG + | Commercial |
|---|---|---|---|
| | PBG | 3% MP300L | benchmark |
| C-01 Mineral Oil w/CB | 41 | 47 | 41 |
| C-S-17 Fluid make up | 46 | 49 | 49 |
| W-20 D Pigment/Sebum | 60 | 65 | 68 |
| Cooked beef fat 131KC | 52 | 59 | 56 |
| NZ-H002 Lard/Carotene stain | 34 | 37 | 36 |
| C-S-98 Sebum | 34 | 47 | 35 |
| CS-07 Grass | 41 | 63 | 50 |
| E-117 blood/milk/ink | 26 | 48 | 32 |
| CS -44-Chocolate | 40 | 43 | 41 |
| C-S-28 Rice starch, colored | 36 | 63 | 39 |
| KC-H097 Oatmeal w/Chocolate | 40 | 40 | 42 |
| C-S-15 Bill(blue)berry Juice | 49 | 50 | 49 |
| C-S-97 Tea | 45 | 46 | 44 |
| WE5FSMWKC French Mustard | 30 | 33 | 35 |
| W-80A Prewashed, Tracer fabric | 73 | 75 | 73 |
| Sum | 649 | 764 | 693 |

The results clearly show that the plant-based green detergent formulation (PBG) where surfactants are partly replaced by enzymes improves the wash performance as compared the commercial benchmark detergent (higher values indicate better wash performance).

### Example 5: Results from Evaluation of Whiteness

The TOM assay (Example 3) was used to evaluate Whiteness as described in Example 3. Whiteness effect of the following three detergents was evaluated:
Plant-based green detergent (PBG)
Plant-based green detergent (PBG) with addition of 0.2 ppm cellulase having SEQ ID NO: 1
Commercial benchmark detergent (Ecover Non-bio, no enzyme)
1.5% Medley® Pure 300L (MP300L) in each condition as background enzyme

The outcome of the Whiteness evaluation on different stains is provided below:

TABLE 7
Delta remission at 460 nm values for Whiteness

| | | PBG + | |
|---|---|---|---|
| | | 0.2 ppm | |
| | | SEQ ID | Commercial |
| Tracer or Fabric (White) | PBG | NO: 1 | benchmark |
| W-80A knitted cotton | 64 | 73 | 70 |
| CN-42 100% cotton with optical | 69 | 80 | 73 |
| brightener | | | |
| CN-11 woven cotton without optical | 76 | 80 | 78 |
| brightener | | | |
| T-266 viscose | 62 | 73 | 67 |
| W-10A 100% cotton | 70 | 74 | 74 |
| W-20A Polyester/Cotton 65/35 | 69 | 73 | 75 |
| T-720 polyester | 50 | 50 | 74 |
| W-30A polyester | 64 | 64 | 71 |
| W-40A polyamide | 74 | 75 | 74 |

The results clearly show that the plant-based green detergent formulation (PBG) where surfactants are partly replaced by the cellulase having SEQ ID NO: 1 improves the Whiteness as compared the commercial benchmark detergent (higher values indicate better performance).

### Example 6: Full-Scale Wash (FSW) Assay

Wash performance in a laundry setup is ultimately tested in a programmable electronic household washing machine and Miele machine (eg: Miele 1935 WPSWTL, fuzzy logic disabled) is generally used as a reference machine due to its stable performance and regular quality of outcomes. Standard wash conditions as listed in the table is used for testing. The washed and rinsed swatches are left to dry overnight in a drying cabinet and measured as indicated in table 8 below.

TABLE 8
Conditions for FSW Trial for WP

| Detergent dosage | 50 | g/wash |
|---|---|---|
| Program | Cottons, Short, Water Plus | |
| Fabric load | Up to 4 kg (CO:PE = 65:35) | |
| pH | Unadjusted | |
| Main wash time | 51 | minutes |
| Temperature | Adjusted to 20° C., 30° C. or 40° C. | |
| Water hardness | 14° | dH |

| | |
|---|---|
| Ca^{2+:}Mg^{2+:}CO₃²⁻ ratio | 4:1:7.5 |
| Soil | W-SBL2004 |

TABLE 9
Conditions for FSW Trial for whiteness

| Detergent dosage | 50 | g/wash |
|---|---|---|
| Program | Cottons, Short, Water Plus | |
| Fabric load | Up to 4 kg (CO:PE = 65:35) with tracers and | |
| | real items | |
| pH | Unadjusted | |
| Main wash time | 51 | minutes |
| Temperature | Adjusted to 20° C. or 40° C. | |
| Water hardness | 14° | dH |

| | |
|---|---|
| Ca^{2+:}Mg^{2+:}CO₃²⁻ ratio | 4:1:7.5 |
| Soil | 8 pieces of W-SBL2004 and 0.1 g/L of carbon |
| | black |

### Example 7: Full-Scale Wash (FSW) for Evaluation of Whiteness

Full-scale wash assay (Example 6, Table 9) was used to evaluate whiteness.

Whiteness effect of the following detergents was evaluated:
Plant-based green detergent (PBG) with addition of 0.2 ppm cellulase having SEQ ID NO: 1 and 0.5 ppm phosphodiesterase having SEQ ID NO: 2 and 3% Medley Pure 300L
Ecover Washmittel, purchased in Germany, July 2022
Persil Kraft Gel, purchased in Germany, July 2022
Skip Active Clean, purchased in France, July 2022

All detergent/textile combinations were washed at 20° C. and 40° C. The outcome of the whiteness evaluation on the different textiles is provided below (Table 10a and 10b).

TABLE 10a
Performance of Plant Based Green detergent
compared to commercial detergents

| | | W-12AW, | W-20A, | | |
|---|---|---|---|---|---|
| | Temper- | Cotton | Poly- | W-30A, | W-40A, |
| Detergent | ature | Terry | cotton | Polyester | Polyamide |
| PBG + Enzyme | 20 C. | 76 | 73 | 56 | 74 |
| blend | 40 C. | 76 | 70 | 70 | 78 |
| Ecover Wash- | 20 C. | 66 | 57 | 56 | 68 |
| mittel | 40 C. | 59 | 58 | 62 | 78 |
| Persil Kraft Gel | 20 C. | 64 | 73 | 63 | 77 |
| | 40 C. | 59 | 62 | 61 | 81 |
| Skip Active | 20 C. | 61 | 54 | 53 | 66 |
| Clean | 40 C. | 60 | 66 | 64 | 78 |

TABLE 10b
Performance of Plant Based Green detergent
compared to commercial detergents

| Detergent | Temperature | W-10A, Cotton | CN-42, Cotton | W-80A |
|---|---|---|---|---|
| PBG + Enzyme | 20 C. | 80 | 79 | 83 |
| blend | 40 C. | 81 | 80 | 80 |
| Ecover Wash- | 20 C. | 63 | 70 | 72 |
| mittel | 40 C. | 56 | 62 | 68 |
| Persil Kraft Gel | 20 C. | 58 | 70 | 72 |
| | 40 C. | 60 | 66 | 67 |
| Skip Active | 20 C. | 61 | 67 | 69 |
| Clean | 40 C. | 58 | 64 | 68 |

The results clearly show that the plant-based green detergent formulation (PBG) where surfactants are partly replaced by the cellulase having SEQ ID NO: 1 and the phosphodiesterase having SEQ ID NO: 2 improves the Whiteness as compared the commercial benchmark detergents both at 20° C. and 40° C. (higher values indicate better performance).

### Example 8: Full-Scale Wash (FSW) for Evaluation of WP

Full-scale wash assay (Example 6, Table 8) was used to evaluate WP.

WP effect of the following detergents was evaluated:
Plant-based green detergent (PBG) and addition of 0.2 ppm cellulase having SEQ ID NO: 1 and 0.5 ppm phosphodiesterase having SEQ ID NO: 2 and 3% Medley Pure 300L
Ecover Washmittel, purchased in Germany, July 2022
Persil Kraft Gel, purchased in Germany, July 2022.
Skip Active Clean, purchased in France, July 2022

All detergent/textile combinations were washed at 20° C. and 40° C. The outcome of the WP evaluation on the different textiles is provided below (Table 11a and 11b).

The results clearly show that the plant-based green detergent formulation (PBG) where surfactants are partly replaced by the cellulase having SEQ ID NO: 1 and the phosphodiesterase having SEQ ID NO: 2 improves the wash performance as compared the commercial benchmark detergents both at 20° C. and 40° C. (higher values indicate better performance).

TABLE 11a
Delta remission at 460 nm values for FSW at 20° C.

| | PGB + | | Persil | |
|---|---|---|---|---|
| | Enzyme | Ecover | Kraft | |
| Stains (AISE Plus) | blend | Bio | Gel | Skip |
| C-01 Mineral oil with Carbon | 60.1 | 58.5 | 62.0 | 56.6 |
| black | | | | |
| PCS-132; Pigment sebum | 58.6 | 63.0 | 62.2 | 58.8 |
| CS-132; High Discriminative | 74.8 | 74.1 | 75.6 | 69.9 |
| Sebum | | | | |
| C-S-10; Butter fat with colorant | 64.7 | 67.7 | 66.1 | 57.8 |
| WE5BBPC2; Cooked beef fat | 77.5 | 81.0 | 93.0 | 81.0 |
| C-S-17; Fluid make-up | 51.0 | 54.2 | 55.3 | 48.4 |
| CS-32; Sebum BEY with carbon | 42.6 | 43.2 | 42.3 | 39.3 |
| black on Cotton | | | | |
| PC10; Pigment, oil, Milk | 73.4 | 44.8 | 46.9 | 47.6 |
| WE5DASBWKC; Blood | 88.5 | 70.7 | 70.4 | 71.2 |
| C-S-07; Grass | 63.9 | 46.4 | 52.0 | 46.1 |
| WE5GMWKC; Grass/Mud | 54.3 | 46.0 | 49.6 | 47.4 |
| E-117; Blood, Milk, Ink | 60.7 | 29.1 | 51.1 | 44.9 |
| C-S-406; Salad dressing Balsamico | 64.3 | 55.0 | 58.5 | 48.3 |
| C-S-26; Corn starch, coloured | 70.2 | 69.6 | 73.8 | 67.4 |
| C-S-44; Chocolate drink, pure | 46.2 | 46.9 | 46.2 | 41.4 |
| C-S-68; Chocolate ice cream on | 74.2 | 68.0 | 70.5 | 68.2 |
| Cotton | | | | |
| KC-H097; Cocoa/Oat milk | 92.0 | 59.5 | 55.1 | 54.5 |
| KCH-141; Pectin no sugar | 90.0 | 67.1 | 53.2 | 34.0 |
| P01-KC/Tangerine Pectin - Knitted | 90.8 | 86.6 | 77.9 | 72.8 |
| Cotton | | | | |
| CFT PC-H344; DNA stain | 65.9 | 52.1 | 53.7 | 52.6 |
| W-10 J Tea | 54.8 | 50.7 | 55.6 | 52.2 |
| KC-H109 Coffee | 43.7 | 43.6 | 47.3 | 38.6 |
| KC-H026 Red wine | 49.6 | 49.5 | 51.6 | 47.3 |
| WE5FSMWKC French Squeezy | 41.9 | 46.3 | 44.9 | 41.8 |
| Mustard | | | | |
| WE5TPWKC Tomato Puree | 75.8 | 72.0 | 68.2 | 63.2 |
| C-S-15; Bil(blue)berry juice | 53.2 | 53.2 | 54.2 | 52.8 |
| Sum of stains | 1683 | 1499 | 1537 | 1404 |

TABLE 11b
Delta remission at 460 nm values for FSW at 40° C.

| | PGB + | | Persil | |
|---|---|---|---|---|
| | Enzyme | Ecover | Kraft | |
| Stains | blend | Bio | Gel | Skip |
| C-01 Mineral oil with Carbon | 61.8 | 60.8 | 64.0 | 60.6 |
| black | | | | |
| PCS-132; Pigment sebum | 65.2 | 68.3 | 70.5 | 63.3 |
| CS-132; High Discriminative | 77.9 | 78.6 | 81.8 | 76.3 |
| Sebum | | | | |
| C-S-10; Butter fat with colorant | 63.8 | 65.4 | 68.3 | 60.1 |
| WE5BBPC2; Cooked beef fat | 85.9 | 90.8 | 93.0 | 89.3 |
| C-S-17; Fluid make-up | 68.8 | 67.5 | 68.1 | 54.7 |
| CS-32; Sebum BEY with carbon | 45.5 | 44.9 | 44.9 | 41.3 |
| black on Cotton | | | | |
| PC10; Pigment, oil, Milk | 79.9 | 49.5 | 51.2 | 49.6 |
| WE5DASBWKC; Blood | 94.4 | 73.4 | 81.3 | 74.4 |
| C-S-07; Grass | 75.3 | 49.2 | 67.5 | 46.3 |
| WE5GMWKC; Grass/Mud | 59.9 | 49.4 | 55.4 | 52.8 |
| E-117; Blood, Milk, Ink | 67.7 | 42.0 | 62.9 | 49.3 |
| C-S-406; Salad dressing Balsamico | 65.2 | 62.3 | 62.5 | 53.5 |
| C-S-26; Corn starch, coloured | 74.3 | 72.3 | 79.1 | 71.3 |
| C-S-44; Chocolate drink, pure | 46.5 | 45.7 | 44.6 | 41.4 |
| C-S-68; Chocolate ice cream on | 80.0 | 71.5 | 75.3 | 68.6 |
| Cotton | | | | |
| KC-H097; Cocoa/Oat milk | 103.5 | 71.5 | 57.9 | 52.2 |
| KCH-141; Pectin no sugar | 91.3 | 90.4 | 90.6 | 86.8 |
| P01-KC/Tangerine Pectin - Knitted | 94.1 | 92.7 | 76.0 | 68.7 |
| Cotton | | | | |
| CFT PC-H344; DNA stain | 62.5 | 59.1 | 57.7 | 56.9 |
| W-10 J Tea | 45.4 | 46.3 | 50.7 | 44.7 |
| KC-H109 Coffee | 45.5 | 45.1 | 48.2 | 42.5 |
| KC-H026 Red wine | 43.9 | 42.7 | 47.0 | 43.0 |
| WE5FSMWKC French Squeezy | 68.5 | 61.2 | 57.6 | 58.8 |
| Mustard | | | | |
| WE5TPWKC Tomato Puree | 81.8 | 73.9 | 71.6 | 65.3 |
| C-S-15; Bil(blue)berry juice | 49.2 | 49.3 | 54.6 | 50.1 |
| Sum delta remission | 1798 | 1624 | 1682 | 1522 |

1. A liquid laundry detergent composition comprising
a. 7-9% AES
b. 3-5% APG
c. 3-5% builder
d. 1-3% soap
e. 3-5% polyol
wherein at least AES and APG are plant-based surfactants.

2. The liquid laundry detergent composition according to claim 1 further comprising less than 0.7% preservative and a less than 0.7% viscosity modifier.

3. The liquid laundry detergent composition according to claim 1, wherein
a. AES is SLES, preferably SLES, 2EO.
b. APG is APG, C₈-C₁₄ glucoside
c. Builder is sodium citrate
d. Soap is obtained from coco fatty acid
e. Polyol is glycerol.

4. The liquid laundry detergent composition according to claim 2, wherein the preservative is 0.5% phenoxy ethanol and the viscosity modifier is 0.5% sodium chloride.

5. A liquid laundry detergent composition according to claim 1 comprising
a. 8% SLES, 2EO
b. 4% C₈-C₁₄ glucoside
c. 4% sodium citrate
d. 2% soap obtained from coco fatty acid
e. 4% glycerol.

6. The liquid laundry detergent composition according to claim 1 further comprising one or more enzymes selected for group consisting of amylases, proteases, peroxidases, cellulases, betaglucanases, xyloglucanases, hemicellulases, xanthanases, xanthan lyases, lipases, acyl transferases, phospholipases, esterases, laccases, catalases, aryl esterases, amylases, alpha-amylases, glucoamylases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases, pectin methylesterases, cellobiohydrolases, transglutaminases, licheninases, laminarinases, and DNAses, or any combination thereof.

7. The liquid laundry detergent composition according to claim 1, wherein the AES and APG are derived from palm kernel oil or coconut oil and glucose and vegetable oils respectively.

8. The liquid laundry detergent composition according to claim 1, wherein the pH of the formulation when dissolved 3.3 g/l in demineralised water at 25° C. is from pH 4 to 10, preferably from 6 to 9, more preferably from 8 to 9.

9. A domestic method for treating a textile, comprising the steps of
a. Treating a textile with an aqueous solution of 0.15 to 20 g/L, more preferably 1 to 10 g/L of the detergent composition according to claim 1;
b. Optionally rinsing and drying the textile.

10. The liquid laundry detergent of claim 1, comprising 8% AES.

11. The liquid laundry detergent of claim 1, comprising 4% APG.

12. The liquid laundry detergent of claim 1, comprising 4% builder.

13. The liquid laundry detergent of claim 1, comprising 2% soap.

14. The liquid laundry detergent of claim 1, comprising 4% polyol.


SEQUENCE LISTING (2 sequences)

SEQ ID NO: 1 - protein, 415 aa, Humicola insolens
QKPGETKEVHPQLTTFRCTKRGGCKPATNFIVLDSLSHPIHRAEGLGPGGCGDWGNPPPKDVCPDVESCAKNCIMEGIPDYSQYGVTTNGTSLRLQHILPDGRVPSPRVYLLDKTKRRYEMLHLTGFEFTFDVDATKLPCGMNSALYLSEMHPTGAKSKYNPGGAYYGTGYCDAQCFVTPFINGLGNIEGKGSCCNEMDIWEANSRASHVAPHTCNKKGLYLCEGEECAFEGVCDKNGCGWNNYRVNVTDYYGRGEEFKVNTLKPFTVVTQFLANRRGKLEKIHRFYVQDGKVIESFYTNKEGVPYTNMIDDEFCEATGSRKYMELGATQGMGEALTRGMVLAMSIWWDQGGNMEWLDHGEAGPCAKGEGAPSNIVQVEPFPEVTYTNLRWGEIGSTYQEVQKPKPKPGHGPRSD

SEQ ID NO: 2 - protein, 221 aa, Aspergillus oryzae
VPVNPEPDATSVENVALKTGSGDSQSDPIKADLEVKGQSALPFDVDCWAILCKGAPNVLQRVNEKTKNSNRDRSGANKGPFKDPQKWGIKALPPKNPSWSAQDFKSPEEYAFASSLQGGTNAILAPVNLASQNSQGGVLNGFYSANKVAQFDPSKPQQTKGTWFQITKFTGAAGPYCKALGSNDKSVCDKNKNIAGDWGFDPAKWAYQYDEKNNKFNYVGK